(19) United States
(12) Patent Application Publication
(10) Pub. No.: US 2002/0188577 A1
(43) Pub. Date: Dec. 12, 2002

(54) Finding worst case aggressor set for logically exclusive aggressors during noise analysis

(76) Inventors: Devendra Vidhani, Sunnyvale, CA (US); Joseph C. Ferguson, Santa Cruz, CA (US)

Correspondence Address: ROSENTHAL & OSHA L.L.P., 1221 MCKINNEY AVENUE, SUITE 2800, HOUSTON, TX, 77010, US

(21) Appl. No.: 09/875,716

(22) Filed: Jun. 6, 2001

(51) Int. Cl. G06F 15/18

(52) U.S. Cl. 706/14

(57) ABSTRACT

A method for finding a worst case aggressor set of a victim net based on logically exclusive sets is provided. Further, a software tool that finds a worst case aggressor set of a victim net based on logically exclusive sets is provided. Further, a method for formulating a problem to find a worst case aggressor net of a victim net based on a logically exclusive set is provided. Further, a software tool for formulating a problem to find a worst case aggressor net of a victim net based on a logically exclusive set is provided. Further, a method for solving a problem to find a worst case aggressor net based on logically exclusive sets is provided. Further, a software tool for solving a problem to find a worst case aggressor net based on a logically exclusive net is provided.

### BACKGROUND OF INVENTION

For large, high performance processor designs, noise failures are a significant design and verification concern. Due to non-uniform scaling of interconnects, cross-coupling capacitance between wires results in a considerable fraction of total wire capacitance, causing an increase in cross-coupled noise effects, i.e., “crosstalk.” At the same time, the quest for higher performance circuits pushes designers to use more aggressive but less noise immune circuit structures, such as dynamic logic and unbuffered latches. The combination of high cross-coupling noise and noise sensitive circuit structures results in a significant noise problem, making effective noise analysis methods critical.

During noise analysis, nets, i.e., signals, are divided into two classes: victim nets and aggressor nets. A victim net is a net on which noise is injected by one or more neighboring nets through cross-coupled capacitance. The nets that inject noise onto a victim net are considered to be its aggressor nets. For example, if a first net is in proximity to a second net such that when the value of the second net changes, noise is injected on the first net causing it to glitch, i.e., an electrical spike occurs, then the second net is considered to be the first net's aggressor. Thus, another way to distinguish an aggressor net and a victim net is that the aggressor net is the net that switches state and the victim net is the net that maintains its present state, i.e., is “quiet.”

Note that there is typically a capacitance between a victim net and its aggressor even when the aggressor is not switching. Such a capacitance can be referred to as a “ground capacitance,” and although ground capacitances do affect the functionality of a victim net, noise estimation techniques can account for ground capacitances. However, worst case capacitances created on a victim net due to the switching of its aggressors are more difficult to estimate.

The undesired behavior induced on a victim net can lead to performance degradation because the noise injected on the victim net often propagates to other parts of the processor causing timing failures and/or circuit malfunction. In order to design around such performance degrading effects, noise estimation models are implemented to determine an upper bound on the amount of noise that can be induced on one or more victim nets. However, considering that every victim net is potentially an aggressor of another net and that every aggressor net is potentially also a victim net, the amount of computation needed to generate a reasonable estimate of the noise on a processor caused by such victim-aggressor capacitances can be prohibitively expensive.

### SUMMARY OF INVENTION

According to one aspect of the present invention, a method for finding a worst case aggressor set of a victim net based on a plurality of logically exclusive sets comprises forming a first set, using the first set and the plurality of logically exclusive sets to formulate a problem, and solving the problem to determine a worst case aggressor net of the victim net, where the first set comprises an aggressor net of the victim net, and where the worst case aggressor set comprises the worst case aggressor net.

According to another aspect, a software tool that finds a worst case aggressor set of a victim net comprises a processor, a memory, and software instructions residing in the memory and executable in the processor for performing a series of operations to find a worst case aggressor net based on a plurality of logically exclusive sets.

According to another aspect, a method for solving a problem to find a worst case aggressor net based on a logically exclusive set comprises using a first representation to represent the logically exclusive set, selecting the first representation, selecting a second representation, removing an association of the first representation, removing the first representation, removing an association of the second representation, removing the second representation, and returning the adjacent net represented by the second representation as the worst case aggressor net, where the second representation represents an adjacent net of the first representation.

According to another aspect, a software tool comprises a processor, a memory, and software instructions residing in the memory and executable in the processor for performing a series of operations for solving a problem to find a worst case aggressor net based on a logically exclusive set.

According to another aspect, a method for formulating a problem to find a worst case aggressor net of a victim net based on a logically exclusive set comprises using a first representation to represent a net, using a second representation to represent a set, and selectively creating an association between the first representation and the second representation when the net is part of the set, where the net is an aggressor net of the victim net and is part of the logically exclusive set, and where the set is the logically exclusive set.

According to another aspect, a software tool comprises a processor, a memory, and software instructions residing in the memory and executable in the processor for performing a series of operations for formulating a problem to find a worst case aggressor net of a victim net based on a logically exclusive set.

Other aspects and advantages of the invention will be apparent from the following description and the appended claims.

### BRIEF DESCRIPTION OF DRAWINGS

FIG. 1 shows a flow process in accordance with an embodiment of the present invention.

FIG. 2 shows a graphical model in accordance with the embodiment shown in FIG. 1.

FIG. 3 shows a flow process in accordance with the embodiment shown in FIG. 2.

FIG. 4a shows an exemplary graphical model in accordance with an embodiment of the present invention.

FIG. 4b shows an exemplary graphical model in accordance with the embodiment shown in FIG. 4a.

FIG. 5a shows an exemplary graphical model in accordance with the embodiment shown in FIG. 4b.

FIG. 5b shows an exemplary graphical model in accordance with the embodiment shown in FIG. 5a.

### DETAILED DESCRIPTION

The present invention relates to a method for performing noise analysis based on the logical exclusivity of signals. Further, the present invention relates to a method for performing noise analysis when nets belong to multiple logically exclusive sets. Further, the present invention relates to a method for choosing worst case aggressors from sets of logically exclusive aggressors for noise analysis on a victim net. Further, the present invention relates to a method for finding a worst case aggressor set for logically exclusive aggressors during noise analysis. Further, the present invention relates to a method for basing an estimated amount of noise caused by cross-coupled capacitances in a circuit.

The present invention uses the idea that for nets in a logically exclusive set, at most only one net can switch states in one direction at a given time. During noise analysis of a “quiet” victim net, if the victim net is capacitively coupled to one or more aggressor nets that are part of a logically exclusive aggressor set, then only one of those aggressor nets can switch at a given time. The coupling capacitances between the victim net and other aggressor nets are considered to be ground capacitances of the victim net because these other aggressor nets are not switching due to the logical exclusivity of the aggressor nets in the aggressor set. Because a processor typically has multiple logically exclusive sets of nets, it becomes necessary to be able to determine worst case aggressors from multiple logically exclusive sets of nets. To this, the present invention provides a method by which to remove from consideration all but the worst case aggressor nets of a particular victim net, where the worst case aggressor nets represent the worst potential case of noise injection on the victim net.

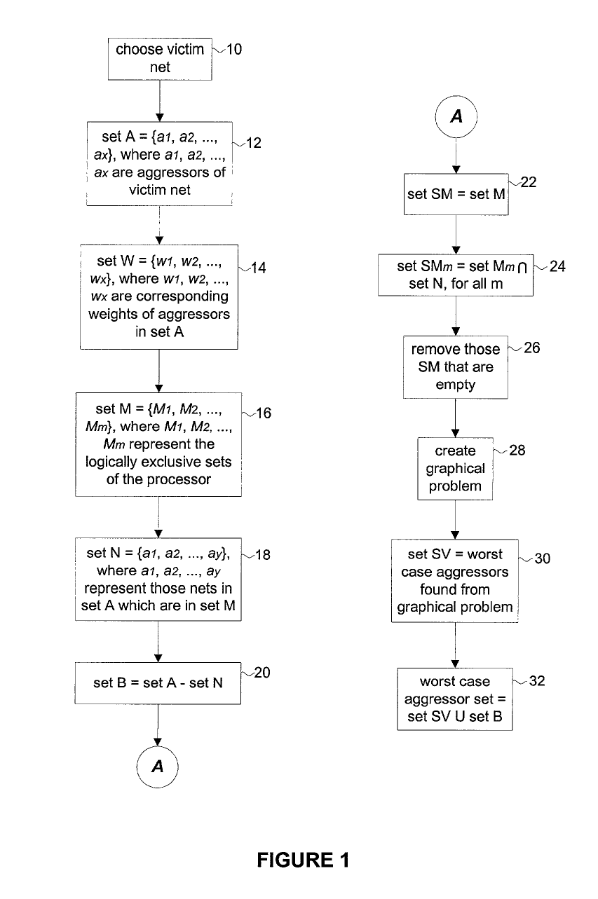

In order to formulate the problem of determining a worst case aggressor set of a victim net from multiple logically exclusive sets, a graphical model is generated. Referring to FIG. 1, an exemplary flow process showing how to generate the graphical model is shown in accordance with an embodiment of the present invention.

Initially, a victim net having x aggressor nets is chosen for noise analysis (step 10). The x aggressor nets, a₁, a₂, . . . , aₓ, belong to a set A (step 12), and have corresponding weights, w₁, w₂, . . . , wₓ, which belong to a set W (step 14). Additionally, consider that a processor has m logically exclusive sets of nets, M₁, M₂, . . . Mₘ, which belong to a set M (step 16).

Of the x aggressor nets in set A, some may not have logical relationships with other nets, and therefore will not be part of any of the m logically exclusive sets of nets in set M. However, for those aggressor nets in set A that are part of at least one of the m logically exclusive sets of nets in set M, a set N is created (step 18), where set N contains aggressor nets a₁, a₂, . . . , a_{y}.

Next, a set B is created by subtracting set N from set A (step 20). Set B contains those aggressor nets which are not part of any of the m logically exclusive sets of nets in set M.

Thereafter, each of the m logically exclusive sets of nets, M₁, M₂, . . . Mₘ, is respectively reduced to sets SM₁, SM₂, . . . SMₘ, such that every net in sets SM₁, SM₂, . . . SMₘ belongs to set N (steps 22 and 24), where sets SM₁, SM₂, . . . SMₘ belong to a set SM. Those skilled in the art will appreciate that because the reduction of the m logically exclusive sets of nets to sets SM₁, SM₂, . . . SMₘ may result in some of the sets in set SM containing zero elements, such zero element containing sets can be removed from consideration in the noise analysis of the current victim net (step 26).

To determine the remaining aggressor nets of the worst case aggressor set, other than the aggressor nets in set B, a graphical model, such as a bipartite graph, is generated (step 28). Those skilled in the art will appreciate that other types of graphical models may be used to formulate the problem of determining the worst case aggressors of one or more victim nets. Further, those skilled in the will appreciate that the generating of a graphical model is synonymous with developing, i.e., formulating, a problem that can be methodically solved. Moreover, those skilled in the art will appreciate that the problem associated with the graphical model may actually be implemented by a technique other than a graphical model, e.g., an implementation in software.

From the graphical model, worst case aggressors are found, where the worst case aggressors found from the graphical model form a set SV (step 30). Then, once set SV is fully generated, the worst case aggressor set is formed by the union of set SV and set B (step 32).

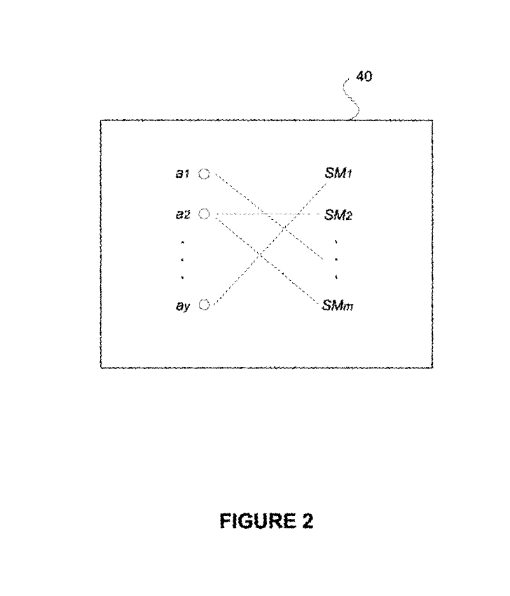

FIG. 2 shows an exemplary graphical model (40) in accordance with the embodiment described above with reference to FIG. 1. The graphical model, G (40), contains nodes for nets a₁, a₂, . . . , a_{y}, which represent the nets in set N, where y represents the number of nets in set N. Additionally, G (40) contains nodes for sets SM₁, SM₂, . . . SMₘ, where m represents the number of sets in set SM. Further, edges between the nodes are created such that there is an edge between a node for a particular net and a node for a particular set if that net belongs to that set. Those skilled in the art will appreciate that although the dotted lines in FIG. 2 represent edges, those edges are shown for illustration and may be different based on different net-set relationships. In other words, the edges in FIG. 2 were placed arbitrarily in G (40) for illustrative purposes, whereas in a graphical model where the net and set values are actually known, edges would be created non-arbitrarily.

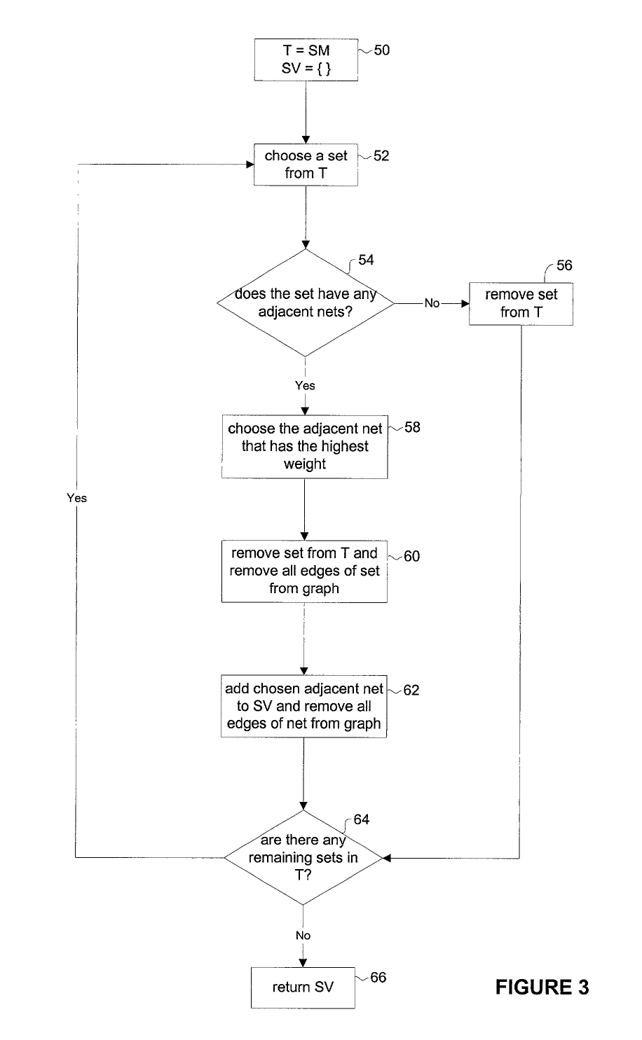

In order to determine the remaining aggressor nets of the worst case aggressor set, other than the aggressor nets in set B, a subset of the nets in G (40) is determined. FIG. 3 shows an exemplary flow process that provides a solution to determining the remaining aggressor nets in accordance with the embodiment shown in FIG. 2.

First, let a set T be equal to set SM such that set T contains sets SM₁, SM₂, . . . SMₘ, where m represents the number of sets in set SM (step 50). Also, initialize an empty set SV (step 50), where set SV is used to contain the worst case aggressors in G (40) and where set SV is the subset of the nets in G (40). Next, a set from set T is chosen (step 52). A determination is then made as to whether the chosen set has any adjacent nets in G (40) (step 54), where adjacent nets are those nets to which a set has an edge. If the chosen set does not have any adjacent nets, then that set is removed from set T and is also removed from G (40) (step 56), where after a determination is made as to whether there are any remaining sets in set T (step 64).

However, if the chosen set has one or more adjacent nets, the adjacent net with the highest weight is chosen (step 58). Thereafter, the chosen set is removed from set T and G (40) and all edges of the chosen set are removed from G (40) (step 60). The chosen net is then added to set SV and all edges of the chosen net are removed from G (40) (step 62). Next, a determination is made as to whether there are any remaining sets in set T (step 64). If there are remaining sets in set T, then another set from set T is chosen (step 52), and the flow process described above is applied to that set. However, if there are no remaining sets in set T, then set SV is returned as the set which contains the worst case aggressor nets in G (40) for a particular victim net (step 66).

An application of the present invention with reference to FIGS. 1, 2, and 3, is described in the following. Consider that a victim net, v, has aggressor nets a₁, a₂, a₃, a₁₅, and a₂₃ which have weights of 15 pF, 20 pF, 10 pF, 5 pF, and 35 pF, respectively, and where a₁, a₂, a₃, a₁₅, and a₂₃ form set A (step 12) and their corresponding weights form set W (step 14). Further, consider that the processor, which v is part of, has logically exclusive sets of nets M₁ and M₂, where M₁={a₁, a₂, a₄, a₁₃} and M₂={a₂, a₃, a₉, a₁₆, a₄₁]} and where M (step 16). Because a₁, a₂, and a₃ are part of at least one of the logically exclusive sets of nets in set M, set N is created, where set N contains a₁, a₂, and a₃ (step 18).

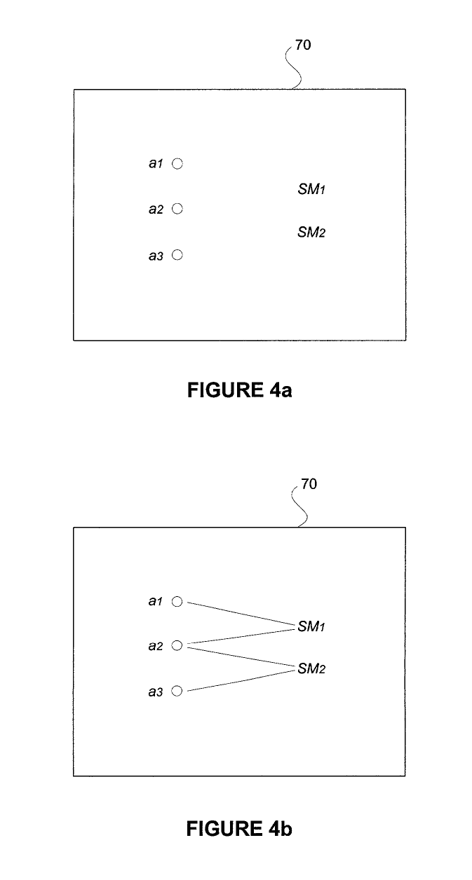

Set B, which is created by subtracting set N from set A (step 20), contains a₁₅ and a₂₃ because these nets are in set A but not in set N. Next, M₁ and M₂ are respectively reduced to SM₁ and SM₂ such that every net in SM₁ and SM₂ belongs to set N (steps 22 and 24). Thus, in this example, SM₁={a₁, a₂} and SM₂={a₂, a₃}. a₄, a₉, a₁₃, a₁₆, and a₄₁ are not included in either SM₁ or SM₂ because none of these nets are part of set N. Because neither SM₁ nor SM₂ are empty, they are not removed from consideration (step 26). Thereafter, a graphical problem is formulated (step 28) based on set SM and set N. A description of this is given with reference to FIGS. 4a and 4b.

Those skilled in the art will understand that because SM₁ and SM₂ are logically exclusive, only a₁ and a₃ can switch at a given time or only a₂ can switch at a given time. If a₁ and a₃ switch, then a₂ does not switch, and 25 pF (15 pF from a₁ plus 10 pF from a₃) may be potentially injected on v. If a₂ switches, then a₁ and a₃ do not switch, and 20 pF (20 pF from a₂) may be potentially injected on v. Therefore, the real worst case noise (also referred to as “optimum solution”) is 25 pF. Those skilled in the art will appreciate that the present invention provides a method by which to determine a value of potential noise injection that is equal to or slightly greater than the optimum solution.

FIGS. 4a and 4b show an exemplary graphical model (70) for the preceding example in accordance with an embodiment of the present invention. FIG. 4a shows that the exemplary graphical model (70) is partly created by including nodes for nets a₁, a₂, . . . a_{y}, which represent the nets in set N, where y represents the number of nets in set N. FIG. 4a also shows that the exemplary graphical model (70) is created by including nodes for sets SM₁ and SM₂. For purposes of the description of the exemplary graphical model (70), a node for a net is referred to as a “net” and a node for a set is referred to as a “set.”

FIG. 4b shows the edges between the nets and sets of the exemplary graphical model (70) shown in FIG. 4a. The edges are created such that there is an edge between a net and a set if that net is a member of that set. For instance, net a₂ belongs to both sets SM₁ and SM₂, and therefore, there is one edge between net a₂ and set SM₁ and another edge between net a₂ and set SM₂.

Based on the exemplary graphical model (70) shown in FIGS. 4a and 4b, the flow process described above with reference to FIG. 3 is applied. First, set SM₁ is chosen (step 52). Because set SM₁ does have one or more adjacent nets (step 54), the adjacent net with the highest weight is chosen (step 58). Here, net a₂, which has a weight of 20 pF, has the highest weight. Therefore, net a₂ is chosen.

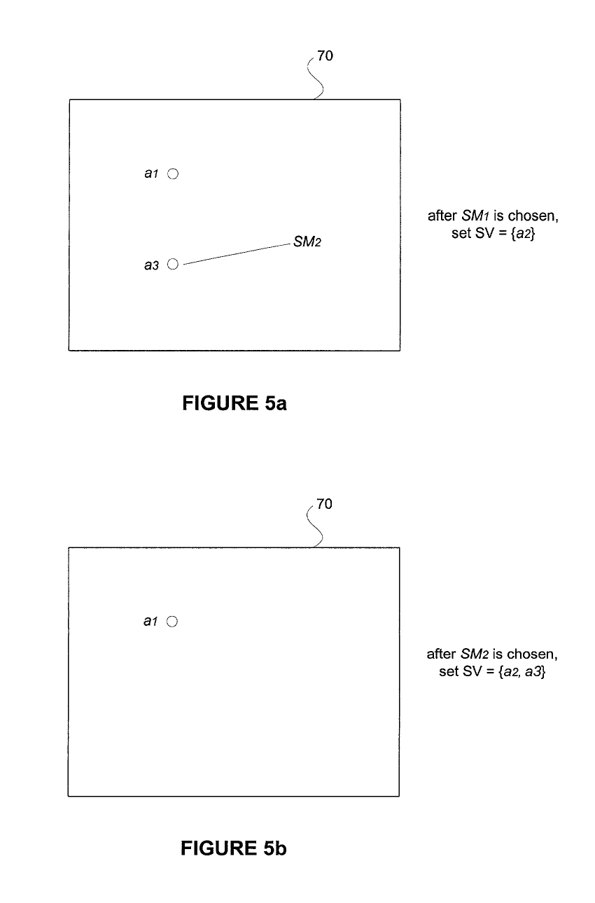

Next, set SM₁ and all of its edges are removed from the exemplary graphical model (70) (step 60). Net a₂ is then added to set SV (step 62), and thereafter, net a₂ and all of its edges are removed from the exemplary graphical model (70) (step 62). FIG. 5a depicts the exemplary graphical model (70) after set SM₁ and net a₂ and all of their respective edges have been removed.

After net a₂ and its edges are removed from the exemplary graphical model (70) (step 62), a determination is made as to whether there are any remaining sets in the exemplary graphical model (step 64). In this example, set SM₂ remains, and therefore, set SM₂ is chosen (step 52). Because set SM₂ does have an adjacent net (step 54), net a₃ is chosen (step 58), where net a₃ has the highest weight because it is the only adjacent net of set SM₂.

Next, set SM₂ and all of its edges are removed from the exemplary graphical model (70) (step 60). Net a₃ is then added to set SV (step 62), and thereafter, net a₃ is removed from the exemplary graphical model (70) (step 62). In the case that net a₃ had any edges, those edges would have been removed from the exemplary graphical model (70). FIG. 5b depicts the exemplary graphical model (70) after set SM₂ and net a₃ and all of their respective edges have been removed.

After net a₃ is removed from the exemplary graphical model (70) (step 62), a determination is made as to whether there are any remaining sets in the exemplary graphical model (70) (step 64). In this example, no sets remain, and therefore set SV is returned (step 30 in FIG. 1 and step 66 in FIG. 2), where SV={a₂, a₃}.

Based on the values of the weights of nets in set SV, a noise estimate of 30 pF (20 pF from a₂ plus 10 pF from a₃) is made. Those skilled in the art will appreciate that this noise estimate is greater than the optimum solution but less than a noise estimate which is made by adding the highest p weights of a plurality of aggressor nets, where p represents the number of sets in SM. Thus, the present invention provides a noise estimate that is “pessimistically accurate,” i.e., is equal to or slightly greater than the real worst case value.

The worst case aggressor set for v, which is formed by the union of set SV and set B (step 32), contains a₂, a₃, a₁₅, and a₂₃.

Advantages of the present invention may include one or more of the following. In some embodiments, because logically exclusive sets of nets are used to determine a worst case aggressor set of a victim net, the potential injection of noise on the victim net can be more accurately analyzed than in cases where logically exclusive sets are not considered.

In some embodiments, because logically exclusive sets of nets are used in noise analysis, noise on a victim net can be analyzed without removing potential aggressor nets from consideration during noise analysis.

In some embodiments, because a graphical noise estimation model is used to formulate a problem of determining worst case aggressors of one or more victim nets, more efficient and structured noise analysis can occur relative to non-graphical noise estimation models.

In some embodiments, because the net with a highest weight is chosen when solving a problem of determining worst case aggressors, the solution is guaranteed to be both pessimistic and accurate, i.e., equal to or slightly greater than a real worst case noise value.

In some embodiments, solving a formulated problem of determining worst case aggressors for noise analysis is polynomial and may run in real-time.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for finding a worst case aggressor set of a victim net based on a plurality of logically exclusive sets, comprising:
forming a first set, wherein the first set comprises an aggressor net of the victim net;
using the first set and the plurality of logically exclusive sets to formulate a problem; and
solving the problem to determine a worst case aggressor net of the victim net, wherein the worst case aggressor set comprises the worst case aggressor net.

2. The method of claim 1, wherein the plurality of logically exclusive sets comprises a mutually exclusive set, and wherein the mutually exclusive set comprises a signal net.

3. The method of claim 1, wherein the aggressor net in the first set has a corresponding weight.

4. The method of claim 1, the problem comprising:
finding the worst case aggressor net of the victim net.

5. The method of claim 1, further comprising:
forming a second set, wherein the second set comprises an aggressor net that is in the first set and that is part of the plurality of logically exclusive sets.

6. The method of claim 5, further comprising:
forming a third set, wherein the third set comprises an aggressor net that is in the first set but is not part of the second set.

7. The method of claim 6, wherein the aggressor net in the third set becomes part of the worst case aggressor set.

8. The method of claim 5, comprising:
reducing each of the plurality of logically exclusive sets to a second plurality of logically exclusive sets such that a net in a set of the second plurality of logically exclusive sets is part of the second set.

9. The method of claim 8, wherein an empty set in the second plurality of logically exclusive sets is removed from the second plurality of logically exclusive sets.

10. The method of claim 8, the problem comprising:
using a first representation to represent a net in the second set;
using a second representation to represent a set in the second plurality of logically exclusive sets; and
creating an association between the first representation and the second representation when the net is part of the set.

11. The method of claim 10, wherein the first representation is a first node, and wherein the second representation is a second node.

12. The method of claim 10, wherein the association is an edge.

13. The method of claim 10, further comprising:
selecting the second representation;
selecting an adjacent net of the second representation such that the adjacent net has a weight greater than another adjacent net of the first representation;
adding the adjacent net to the worst case aggressor set;
removing an association of the second representation;
removing the second representation;
removing an association of the adjacent net;
removing the adjacent net; and
returning the worst case aggressor set when there are no representations of the sets of the second plurality of logically exclusive sets remaining in the problem.

14. The method of claim 1, wherein the problem is represented graphically.

15. The method of claim 12, wherein the graphical representation is a bipartite graph.

16. A software tool that finds a worst case aggressor set of a victim net, comprising:
a processor;
a memory; and
software instructions residing in the memory and executable in the processor for performing a series of operations to find a worst case aggressor net based on a plurality of logically exclusive sets.

17. The software tool of claim 16, wherein the plurality of logically exclusive sets comprises a mutually exclusive set, and wherein the mutually exclusive set comprises a signal net.

18. The software tool of claim 16, further comprising:
a portion that forms a first set, wherein the first set comprise an aggressor net of the victim net;
another portion that forms a second set, wherein the second set comprises an aggressor net that is part of the first set and that is part of the plurality of logically exclusive sets;
another portion that forms a third set, wherein the third set comprises an aggressor net that is part of the first set but is not part of the second set;
another portion that reduces the plurality of logically exclusive sets to a second plurality of logically exclusive sets such that a net in a set of the second plurality of logically exclusive sets is part of the second set; and
another portion that formulates a problem based on the second set and the second plurality of logically exclusive sets.

19. The software tool of claim 18, wherein the problem is represented graphically.

20. The software tool of claim 19, wherein the graphical representation is a bipartite graph.

21. The software tool of claim 18, wherein the aggressor net in the first set has a corresponding weight.

22. The software tool of claim 18, wherein the worst case aggressor set comprises an aggressor net in the third set.

23. The software tool of claim 18, wherein an empty set in the second plurality of logically exclusive sets is removed from the second plurality of logically exclusive sets.

24. The software tool of claim 18, the problem comprising:
a portion that uses a first representation to represent a net in the second set;
another portion that uses a second representation to represent a set in the second plurality of logically exclusive sets; and
another portion that creates an association between the first representation and the second representation when the net is part of the set.

25. The software tool of claim 24, wherein solving the problem determines the worst case aggressor net, the software tool further comprising:
a portion that selects a set in the second plurality of logically exclusive sets;
another portion that selects an adjacent net of the set such that the adjacent net has a weight greater than another adjacent net of the set;
another portion that adds the adjacent net to the worst case aggressor set;
another portion that removes an association of the set;
another portion that removes the set;
another portion that removes an association of the adjacent net;
another portion that removes the adjacent net; and
another portion that returns the worst case aggressor set when there are no sets of the second plurality of logically exclusive sets remaining.

26. A method for solving a problem to find a worst case aggressor net based on a logically exclusive set, comprising:
using a first representation to represent the logically exclusive set;
selecting the first representation;
selecting a second representation, wherein the second representation represents an adjacent net of the first representation;
removing an association of the first representation;
removing the first representation;
removing an association of the second representation;
removing the second representation; and
returning the adjacent net represented by the second representation as the worst case aggressor net.

27. The method of claim 26, wherein the first representation is a first node, and wherein the second representation is a second node.

28. The method of claim 26, wherein the association of the first representation is an edge, and wherein the association of the second representation is an edge.

29. The method of claim 26, wherein the adjacent net represented by the second representation has a weight greater than another net in the problem.

30. The method of claim 26, wherein the problem is represented graphically.

31. The method of claim 26, wherein the graphical representation is a bipartite graph.

32. A software tool, comprising:
a processor;
a memory; and
software instructions residing in the memory and executable in the processor for performing a series of operations for solving a problem to find a worst case aggressor net based on a logically exclusive set.

33. The software tool of claim 32, further comprising:
a portion that uses a first representation to represent the logically exclusive set;
another portion that selects the first representation;
another portion that selects a second representation, wherein the second representation represents an adjacent net of the first representation;
another portion that removes an association of the first representation;
another portion that removes the first representation;
another portion that removes an association of the second representation;
another portion that removes the second representation; and
another portion that returns the adjacent net represented by the second representation as the worst case aggressor net.

34. The software tool of claim 33, wherein the adjacent net represented by the second representation has a weight greater than another net in the problem.

35. The software tool of claim 32, wherein the problem is represented graphically.

36. The software tool of claim 35, wherein the graphical representation is a bipartite graph.

37. A method for formulating a problem to find a worst case aggressor net of a victim net based on a logically exclusive set, comprising:
using a first representation to represent a net, wherein the net is an aggressor net of the victim net and is part of the logically exclusive set;
using a second representation to represent a set, wherein the set is the logically exclusive set; and
selectively creating an association between the first representation and the second representation when the net is part of the set.

38. The method of claim 37, wherein the first representation is a first node, and wherein the second representation is a second node.

39. The method of claim 37, wherein the association is an edge.

40. A software tool, comprising:
a processor;
a memory; and
software instructions residing in the memory and executable in the processor for performing a series of operations for formulating a problem to find a worst case aggressor net of a victim net based on a logically exclusive set.

41. The software tool of claim 40, further comprising:
a portion that uses a first representation to represent a net, wherein the net is an aggressor net of the victim net and is part of the logically exclusive set;
another portion that uses a second representation to represent a set, wherein the set is the logically exclusive set; and
another portion that selectively creates an association between the first representation and the second representation when the net is part of the set.
